(19) United States
(12) Patent Application Publication
(10) Pub. No.: US 2020/0198636 A1
(43) Pub. Date: Jun. 25, 2020

(54) DRIVETRAIN TORQUE DECELERATION

(71) Applicant: Continental Automotive Systems Inc., Auburn Hills, MI (US)

(72) Inventors: Naren Dhansri, West Bloomfield, MI (US); Clinton Lee Schumann, Holly, MI (US)

(21) Appl. No.: 16/275,624

(22) Filed: Feb. 14, 2019

Related U.S. Application Data
(60) Provisional application No. 62/783,545, filed on Dec. 21, 2018.

(51) Int. Cl. B60W 30/18; B60W 10/10; B60W 10/16; B60W 10/119; B60W 50/029

(52) U.S. Cl. CPC B60W 30/18136; B60W 10/10; B60W 10/16; B60W 10/119; B60W 2720/406; B60W 2710/1005; B60W 2710/125; B60W 2720/403; B60W 50/029

(57) ABSTRACT

A disclosed vehicle braking system according to an exemplary embodiment of this disclosure includes a vehicle body having a first wheel and a second wheel, and a braking system having a first brake at the first wheel and a second brake at the second wheel. The braking system is configured to apply a brake torque to each of the first and second wheels. A drivetrain couples the first and second wheels and is configured to transfer torque between the first and second wheels. A controller is configured to detect a failure condition resulting in one of the first and second wheels becoming a non-braked wheel and command the drivetrain to transfer brake torque to the non-braked wheel. A method of braking a vehicle is also disclosed.

### CROSS-REFERENCE TO RELATED APPLICATION

This application claims priority to U.S. Provisional Application No. 62/783,545 filed on Dec. 21, 2018.

### TECHNICAL FIELD

The present disclosure relates to a method and system for transferring braking torque to a non-braked wheel during a failure condition.

### BACKGROUND

A vehicle drivetrain generally includes an engine that provides torque to the vehicle wheels through a transmission. Vehicle brake systems generally include a brake arranged at each vehicle wheel operated by a hydraulic or electronic system. In a hydraulic braking system for example, the driver pushes a brake pedal in the vehicle, which depresses a piston in a master cylinder, forcing fluid along the pipe to cylinders at each wheel. As the fluid fills the cylinders at the wheels, the pistons are forced out to apply the brakes. Many vehicle braking systems are arranged with twin hydraulic circuits, in case one should fail. Some twin hydraulic systems have a circuit for the front wheels and a circuit for the rear wheels. This arrangement is known as a tandem axle system. Some twin hydraulic systems have diagonal arrangement, which ties each front wheel with one of the rear wheels. A diagonal arrangement permits one forward wheel to always provide braking torque even when one of the pairs fails.

Modern advancements in vehicular systems have emphasized redundancy in various systems to provide support in case of failures.

### SUMMARY

A disclosed vehicle braking system according to an exemplary embodiment of this disclosure includes a vehicle body having a first wheel and a second wheel, and a braking system having a first brake at the first wheel and a second brake at the second wheel. The braking system is configured to apply a brake torque to each of the first and second wheels. A drivetrain couples the first and second wheels and is configured to transfer torque between the first and second wheels. A controller is configured to detect a failure condition resulting in one of the first and second wheels becoming a non-braked wheel and command the drivetrain to transfer brake torque to the non-braked wheel.

In a further embodiment of the foregoing system, the drivetrain transfers brake torque by locking a differential between the first wheel and the second wheel.

In a further embodiment of the foregoing system, the drivetrain transfers brake torque through a transfer case.

In a further embodiment of the foregoing system, the drivetrain transfers brake torque through a transmission.

In a further embodiment of the foregoing system, the first wheel is a front wheel and the second wheel is a rear wheel.

In a further embodiment of the foregoing system, the first and second wheels are both front wheels or both rear wheels.

In a further embodiment of the foregoing system, the failure condition is a failed brake circuit.

In a further embodiment of the foregoing system, the failed brake circuit is a hydraulic circuit.

In a further embodiment of the foregoing system, the failed brake circuit is an electrical circuit.

In a further embodiment of the foregoing system, the failure condition is a failed brake control module.

A disclosed method of braking a vehicle according to an exemplary embodiment of this disclosure includes detecting a failure condition of a braking system on a vehicle resulting in a non-braked wheel and transferring brake torque through a drivetrain of the vehicle from a second wheel to the non-braked wheel.

In a further embodiment of the foregoing method, the transferring brake torque occurs by locking a differential between the non-braked wheel and the second wheel.

In a further embodiment of the foregoing method, the transferring brake torque occurs through a transfer case.

In a further embodiment of the foregoing method, the transferring brake torque occurs through a transmission.

In a further embodiment of the foregoing method, the non-braked wheel is a front wheel and the second wheel is a rear wheel.

In a further embodiment of the foregoing method, the non-braked wheel and the second wheels are both front wheels or both rear wheels.

In a further embodiment of the foregoing method, the failure condition is a failed brake circuit.

In a further embodiment of the foregoing method, the failed brake circuit is a hydraulic circuit.

In a further embodiment of the foregoing method, the failed brake circuit is an electrical circuit.

In a further embodiment of the foregoing method, the failure condition is a failed brake control module.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 is a schematic view of a vehicle with an exemplary drivetrain and braking system.

FIG. 2 is a flowchart diagram summarizing an example method of providing torque deceleration.

### DETAILED DESCRIPTION

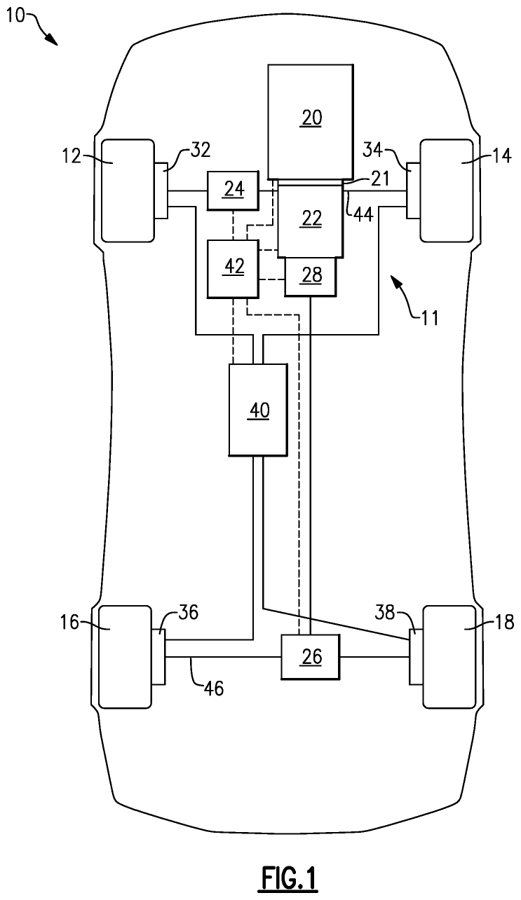

Referring to FIG. 1, an exemplary vehicle 10 has four wheels 12, 14, 16, 18 driven by an engine 20 through a drivetrain 11. Power from the engine 20 is transferred through a torque converter 21 to the transmission 22, which supplies torque to the wheels 12, 14, 16, 18. The front wheels 12, 14 are arranged on a driveshaft 44 and may have a front differential 24 arranged between them, and the rear wheels 16, 18 are arranged on a driveshaft 46 and may have a rear differential 26 between them. Throughout the disclosure, the relative directions of forward and rear are in reference to the direction that an operator for the vehicle 10 would primarily be facing when operating the vehicle 10.

The front and rear differentials 24, 26 may be commandable or locking differentials. A commandable differential has the ability to be open or be locked. When the differentials 24, 26 are open, the two wheels on the same driveshaft 44, 46 may turn separately. When the differentials 24, 26 are locked, the two wheels on the same driveshaft 44, 46 are locked together, and thus turn together. In some examples, a transfer case 28 may be connected to the transmission 22. The transfer case 28 transfers torque from the engine 20 and transmission 22 to the front and rear driveshafts 44, 46 in all wheel drive (AWD) vehicles. In some examples, the transfer case 28 may permit the drivetrain 11 to switch between all wheel drive (AWD) and front wheel drive (FWD).

The drivetrain 11 includes a brake system 40 having a brake 32, 34, 36, 38 arranged at each of the four wheels 12, 14, 16, 18, respectively. The brake system 40 may include a brake control module, and may be a hydraulic brake system or a brake-by-wire system, for example. In a hydraulic brake system, the brakes 32, 34, 36, 38 are controlled via a hydraulic fluid. The brake system 40 may include a master hydraulic cylinder in fluid communication with a cylinder at each of the four brakes 32, 34, 36, 38. In a brake-by-wire system, the brakes 32, 34, 36, 38 are controlled electrically.

The brakes 32, 34, 36, 38 may be connected in pairs. In one example, the front two brakes 32, 34 are connected, and the rear two brakes 36, 38 are connected. This is known as a tandem axle system or a front/rear brake split system. In the event of a failure of one of the pairs of brakes, the other pair would still provide deceleration of the vehicle 10. In another example, each pair of brakes includes one front brake 32, 34 and one rear brake 36, 38. This is known as a diagonal split brake system. In a diagonal split brake, in the event of a failure of one of the pairs of brakes, there will still be some braking at the front of the vehicle.

A controller 42 may be in communication with the engine 20, the torque converter 21, the differentials 24, 26, the transmission 22, the transfer case 28, and/or the braking system 40. The controller 42 may control some or all of these components. The controller 42 may be connected to these drivetrain components via a wire or receive information wirelessly. The controller 42 is configured to detect failure conditions in the vehicle 10, such as failures in the braking system 40. Failures in the braking system 40 might include a failed hydraulic or electrical circuit, for example. The controller 42 is configured to command the drivetrain components to transfer brake torque among the wheels 12, 14, 16, 18 in failure conditions. The brake torque transfer may happen in numerous ways, such as through the transfer case 28, the differentials 24, 26, the engine 20, the torque converter 21, and/or the transmission 22.

In the event of a failure condition, the controller 42 directs the drivetrain 11 to transfer brake torque among the wheels 12, 14, 16, 18. For example, when a failure condition is detected in one of the brakes 32, 34, 36, 38 or the brake system 40, at least one wheel is a non-braked wheel. The controller 42 directs the drivetrain 11 to transfer brake torque from another wheel to the non-braked wheel. When the brakes 32, 34, 36, 38 are arranged in pairs, for example, the brakes at two wheels fail, while the brakes at the other two wheels are operational. The transferring of brake torque from the braked wheels to the non-braked wheels permits deceleration torque to be applied to the non-braked wheels.

In an embodiment, the brakes 32, 34, 36, 38 are arranged in a front/rear brake split arrangement, and the brake torque is transferred through the transfer case 28 or transmission 22. If the front brakes 32, 34 fail, for example, then the rear brakes 36, 38 would supply the vehicle's deceleration. Once the fail condition is recognized, the controller 42 may command the transfer case 28 to couple torque between the front and rear driveshafts 44, 46. Once the driveshafts 44, 46 are coupled, the rear driveshaft brake torque would also be supplied to the front driveshaft 44, increasing the deceleration of the vehicle 10.

In another embodiment, the brakes 32, 34, 36, 38 are arranged in a diagonal split arrangement, and the brake torque is transferred through the differentials 24, 26. That is, when a failure condition is detected, the differential 24, 26 could be commanded to lock and provide brake torque across the driveshaft 44, 46. This arrangement may be beneficial in non-AWD vehicles, for example. Braking one wheel on a driveshaft 44, 46 with the differential 24, 26 locked provides brake torque across the driveshaft 44, 46, and thus the tire friction from both wheels can be utilized.

In another embodiment, the engine 20, torque converter 21, or transmission 22 may be commanded to provide increased engine drag torque, which would also increase the vehicle deceleration. Normally, this drag torque is very low, as the torque converter 21 and transmission 22 are set to provide minimal drag torque during coasting. However, the controller 42 may command higher levels of drag torque when a fail condition is detected to provide more deceleration on the non-braked wheel.

The example vehicle 10 may also include a parking brake, which may provide some limited braking if the braking system 40 fails. In some examples, the parking brake is a mechanical handbrake. The parking brake may be an electrical parking brake in other examples. The controller 42 may also be configured to transfer brake torque created by the a parking brake. For example, if the entire brake system 40 failed, the controller 42 may couple the driveshafts 44, 46 such that brake torque from the parking brake can be used at both the front and rear driveshafts 44, 46 to decelerate the vehicle 10.

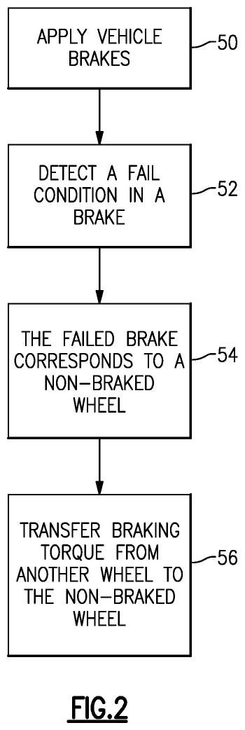

FIG. 2 summarizes an example method of applying drivetrain brake torque for deceleration. A driver of the vehicle 10 applies the brakes at 50, such as by depressing a brake pedal. The controller 42 may detect a failure condition in the braking system 40 at 52. The failure condition may be at one or more of the brakes 32, 34, 36, 38 or may be at a brake control module, in some examples. When the fail condition is detected, at least one of the brakes 32, 34, 36, 38 corresponds to a non-braked wheel at 54. The remaining brakes 32, 34, 36, 38 that do not correspond to a non-braked wheel correspond to braked wheels. The drivetrain 11 transfers brake torque from a braked wheel to the non-braked wheel at 56. The brake torque transfer may occur by locking the differentials 24, 26, or through the transfer case 28, for example. In other examples, the brake torque transfer may occur through the transmission 22, torque converter 21 and/or engine 20. When the brake torque is transferred to the non-braked wheel at 56, both braked and non-braked wheels help to decelerate the vehicle 10.

The disclosed system and method provides additional braking in the event of a failure. In situations where fewer than all of the wheels are providing braking torque, the braking power may be saturated. That is, the friction force of the wheels on the roadway is maximized and any excess braking torque is wasted because the braked wheels is supplied brake torque beyond the optimal level that could be used at those wheels. The disclosed system and method permits use of any wasted braking torque by applying the braking torque at a non-braked wheel. In front/rear brake split vehicles, this may be particularly beneficial when the front brakes fail, as front brakes play a greater part in stopping the vehicle than the rear brakes, because braking throws the vehicle weight forward on to the front wheels.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A vehicle braking system, comprising:
a vehicle body having a first wheel and a second wheel;
a braking system having a first brake at the first wheel and a second brake at the second wheel, the braking system configured to apply a brake torque to each of the first and second wheels;
a drivetrain coupling the first and second wheels and configured to transfer torque between the first and second wheels; and
a controller configured to detect a failure condition resulting in one of the first and second wheels becoming a non-braked wheel and command the drivetrain to transfer brake torque to the non-braked wheel.

2. The vehicle braking system of claim 1, wherein the drivetrain transfers brake torque by locking a differential between the first wheel and the second wheel.

3. The vehicle braking system of claim 1, wherein the drivetrain transfers brake torque through a transfer case.

4. The vehicle braking system of claim 1, wherein the drivetrain transfers brake torque through a transmission.

5. The vehicle braking system of claim 1, wherein the first wheel is a front wheel and the second wheel is a rear wheel.

6. The vehicle braking system of claim 1, wherein the first and second wheels are both front wheels or both rear wheels.

7. The vehicle braking system of claim 1, wherein the failure condition is a failed brake circuit.

8. The vehicle braking system of claim 7, wherein the failed brake circuit is a hydraulic circuit.

9. The vehicle braking system of claim 7, wherein the failed brake circuit is an electrical circuit.

10. The vehicle braking system of claim 1, wherein the failure condition is a failed brake control module.

11. A method of braking a vehicle, the method comprising:
detecting a failure condition of a braking system on a vehicle resulting in a non-braked wheel; and
transferring brake torque through a drivetrain of the vehicle from a second wheel to the non-braked wheel.

12. The method of claim 11, wherein the transferring brake torque occurs by locking a differential between the non-braked wheel and the second wheel.

13. The method of claim 11, wherein the transferring brake torque occurs through a transfer case.

14. The method of claim 11, wherein the transferring brake torque occurs through a transmission.

15. The method of claim 11, wherein the non-braked wheel is a front wheel and the second wheel is a rear wheel.

16. The method of claim 11, wherein the non-braked wheel and the second wheels are both front wheels or both rear wheels.

17. The method of claim 11, wherein the failure condition is a failed brake circuit.

18. The method of claim 17, wherein the failed brake circuit is a hydraulic circuit.

19. The method of claim 17, wherein the failed brake circuit is an electrical circuit.

20. The method of claim 11, wherein the failure condition is a failed brake control module.
